(19) United States
(12) Patent Application Publication
(10) Pub. No.: US 2014/0092252 A1
(43) Pub. Date: Apr. 3, 2014

(54) SYSTEM AND METHOD FOR ANNOTATING VIDEO

(71) Applicant: MAGNA ELECTRONICS, INC., Auburn Hills, MI (US)

(72) Inventor: Axel Nix, Birmingham, MI (US)

(73) Assignee: MAGNA ELECTRONICS INC., Auburn Hills, MI (US)

(21) Appl. No.: 14/116,859

(22) PCT Filed: May 10, 2012
(86) PCT No.: PCT/US2012/037246

§ 371 Date: Nov. 11, 2013

Related U.S. Application Data
(60) Provisional application No. 61/485,373, filed on May 12, 2011.

(51) Int. Cl. H04N 7/18; G06F 11/36

(52) U.S. Cl. CPC H04N 7/181; G06F 11/3668
USPC 348/148

(57) ABSTRACT

A method of providing test data for a vehicle may use the test data to verify the performance of a system in the vehicle under different environmental conditions (such as at night, while it is raining, during high glare conditions, during fog and/or the like). The method entails driving a test vehicle through a selected set of environmental conditions. Environment data, such as, for example, images, are captured while driving the test vehicle. The environment data relates to the environment outside the test vehicle. The environment data may be recorded to a memory. Additionally, environmental condition data relating to the environmental conditions outside the vehicle while it is being driven may be recorded to the memory.

### CROSS REFERENCE TO RELATED APPLICATION

The present application claims the benefit of U.S. provisional application Ser. No. 61/485,373, filed May 12, 2011, which is hereby incorporated herein by reference in its entirety.

### FIELD OF THE INVENTION

The present invention relates to vehicles with systems for determining selected properties of the environment outside the vehicle, such as systems for determining the positions of any obstacles outside the vehicle, and more particularly to systems and methods of developing and assessing the performance of such systems.

### BACKGROUND OF THE INVENTION

Vehicular systems for detecting obstacles in the path of the vehicle are known. While an OEM may require of its supplier of such a system that the system have at least at least a selected success rate, it may in some cases be difficult for the supplier to assert that their system meets the performance requirements of the OEM, particularly in different conditions. It is also sometimes difficult or time consuming for the supplier, when developing the system, to progressively refine and test the system particularly with respect to its performance in selected conditions.

It would be beneficial to provide a way of developing such systems and more particularly for facilitating the improvement of such systems.

### SUMMARY OF THE INVENTION

The present invention provides a system and method for annotating video images captured by a camera of a vehicle. The system processes captured data, such as video image data captured by at least one camera of the vehicle, and determines whether the system is appropriately performing in different environmental conditions.

According to an aspect of the present invention, a method of providing test data for a vehicle is provided. The test data may be used to verify the performance of a system in the vehicle under different environmental conditions (such as, for example, at night, while it is raining, during high glare conditions, during fog, and/or the like). The method entails driving a test vehicle through a selected set of environmental conditions. Environment data, such as, for example, images, are captured while driving the test vehicle. The environment data relates to the environment outside the test vehicle. The environment data is recorded to a memory. Additionally, environmental condition data relating to the environmental conditions outside the vehicle while it is being driven, is recorded to the memory.

According to another aspect of the present invention, a method of providing software to determine selected properties of the environment outside a vehicle is provided, with the method comprising:

(a) driving a test vehicle through a selected set of environmental conditions;

(b) capturing first environment data relating to the environment outside the test vehicle using a first environment sensing system, during step (a);

(c) determining selected properties of the environment;

(d) recording to a memory: the first environment data, vehicle data relating to at least one property of the vehicle during step (a), and environmental condition data relating to the environmental conditions outside the vehicle during step (a);

(e) providing a software module;

(f) using the software module to determine the selected properties of the environment based on the second environment data;

(g) determining a success rate of the software module at determining the selected properties of the environment based on the determinations of the selected properties of the environment made in step (c);

(h) determining whether the success rate determined in step (h) exceeds a selected success rate; and

(i) iteratively repeating steps (f), (g) and (h) using new software modules until the success rate determined at step (h) exceeds the selected success rate.

Optionally, the invention is directed to systems with which either of the above described methods is carried out.

These and other objects, advantages, purposes and features of the present invention will become apparent upon review of the following specification in conjunction with the drawings.

### BRIEF DESCRIPTION OF THE DRAWINGS

The present invention will now be described by way of example only with reference to the attached drawings, in which:

FIG. 1 is a side view of a production vehicle including a system for determining selected properties of the environment outside the production vehicle;

FIG. 1A is a schematic illustration of the system for determining the selected properties included with the vehicle shown in FIG. 1;

FIG. 2 is a side view of a test vehicle including a system for gathering test data to facilitate the development of the system for determining selected properties of the environment outside the production vehicle shown in FIG. 1, in accordance with an embodiment of the present invention;

FIG. 2A is a schematic illustration of the system for gathering test data included in the vehicle shown in FIG. 2;

FIG. 3 is a schematic illustration of a test apparatus for use with data recorded using the test vehicle shown in FIG. 2 during development of the system for determining selected properties of the environment outside the production vehicle shown in FIG. 1; and

FIGS. 4A and 4B illustrate a method of providing software to determine selected properties of the environment outside the production vehicle shown in FIG. 1, using the test data gathered with the test vehicle shown in FIG. 2 and using the test apparatus shown in FIG. 3.

### DETAILED DESCRIPTION OF THE INVENTION

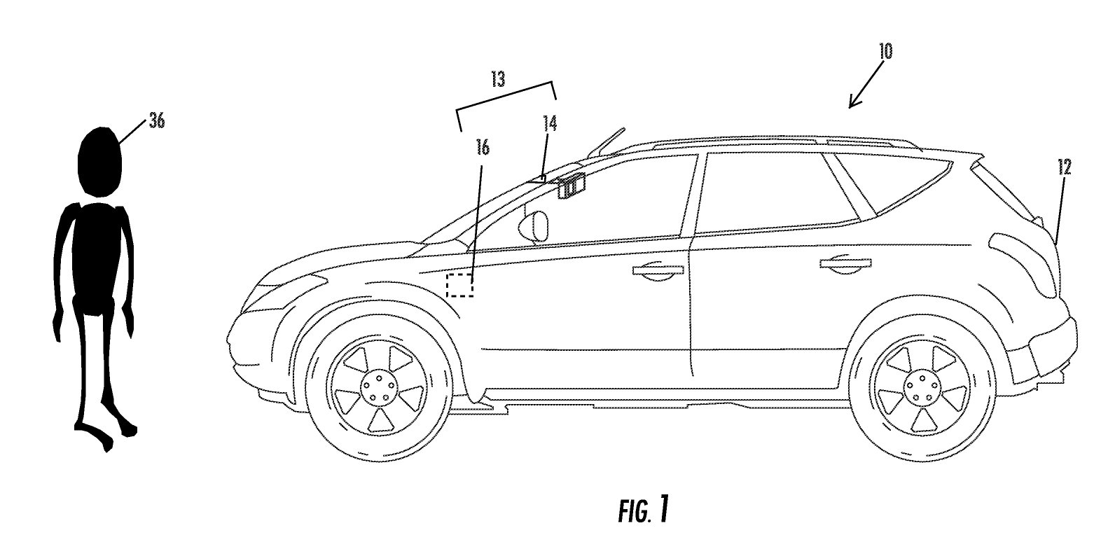

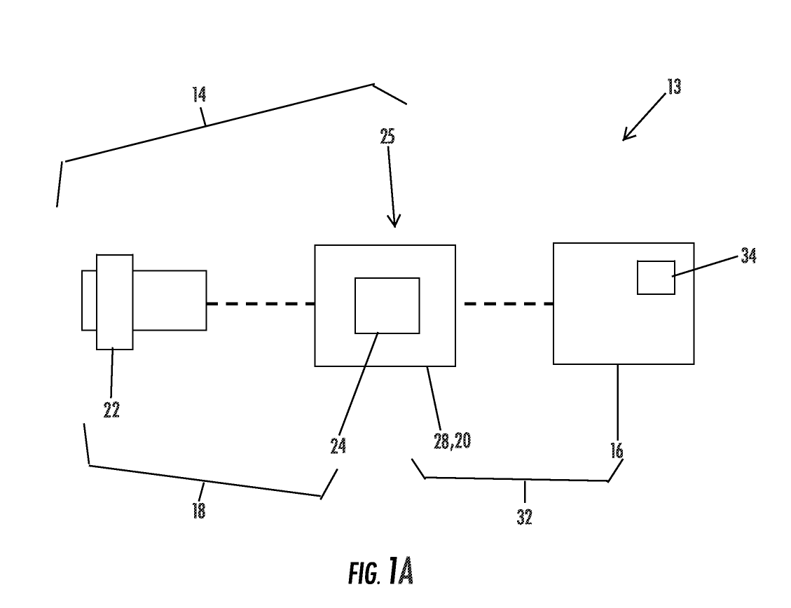

Reference is made to FIG. 1, which shows a vehicle 10 that includes a vehicle body 12, and a system 13 for determining selected properties of the environment outside the vehicle 10. Referring to FIG. 1A, the system 13 includes a camera 14. The vehicle 10 may be referred to as a production vehicle in the sense that it is intended or proposed to be produced and sold, or it is already currently in production. The camera 14 captures images from the environment outside the vehicle 10. The camera 14 itself is made up of a lens assembly 22, an image sensor 24 positioned to receive images from the lens assembly 22, and an electronic control unit (ECU) 16. The image sensor 24 may be any suitable type of image sensor, such as, for example a CMOS image sensor. The image sensor 24 may be any suitable imager, such as a model V024 or a model M024, both of which are made by Aptina Imaging Corporation of San Jose, Calif., USA. The ECU 16 may be provided by Mobileye N.V. whose headquarters are in Amstelveen, The Netherlands, and whose U.S. office is in Agoura Hills, Calif., USA.

The ECU 16 contains a software module 34 that is used to determine selected properties of the environment outside the vehicle 10 based on the image data captured by the camera 14. In the exemplary embodiment, the selected properties include the positions of any obstacles, and more particularly pedestrians, shown at 36 that may be in the path of the vehicle 10, as shown in FIG. 1. It will be understood however that the selected properties could alternatively be any other suitable selected properties.

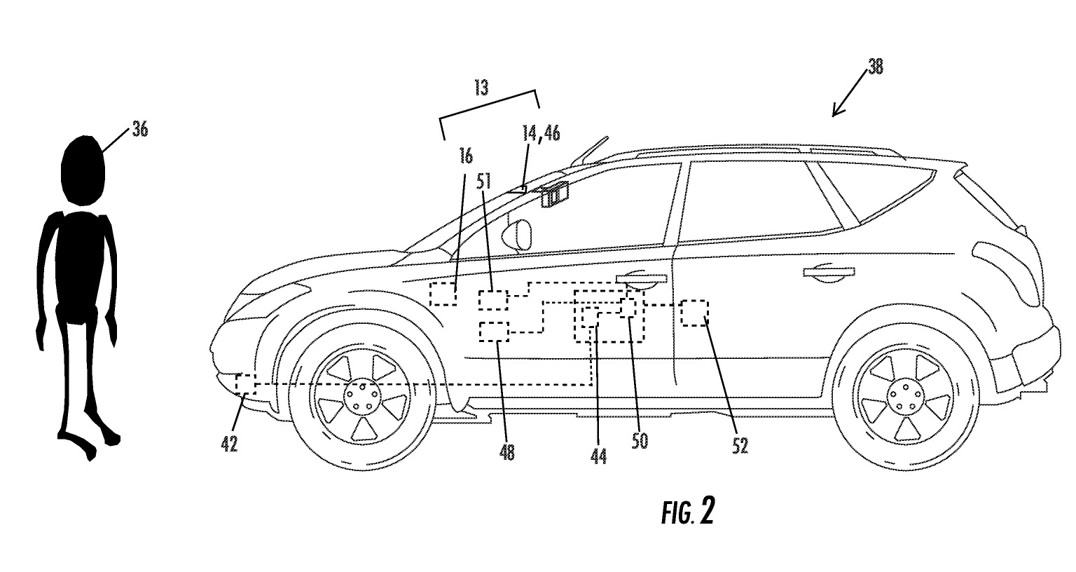

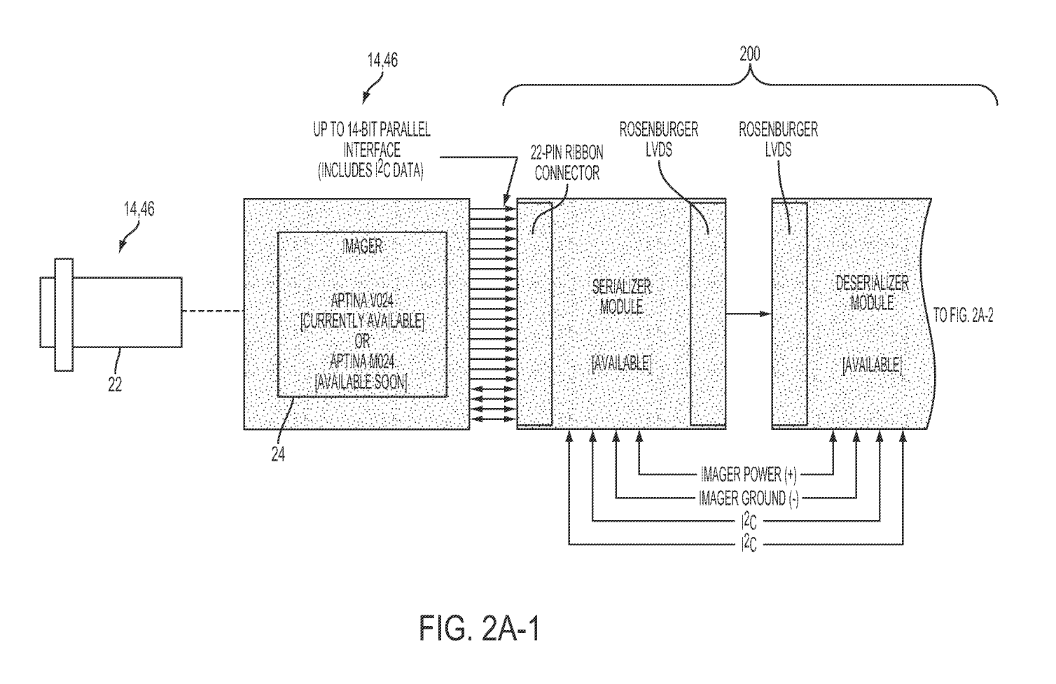

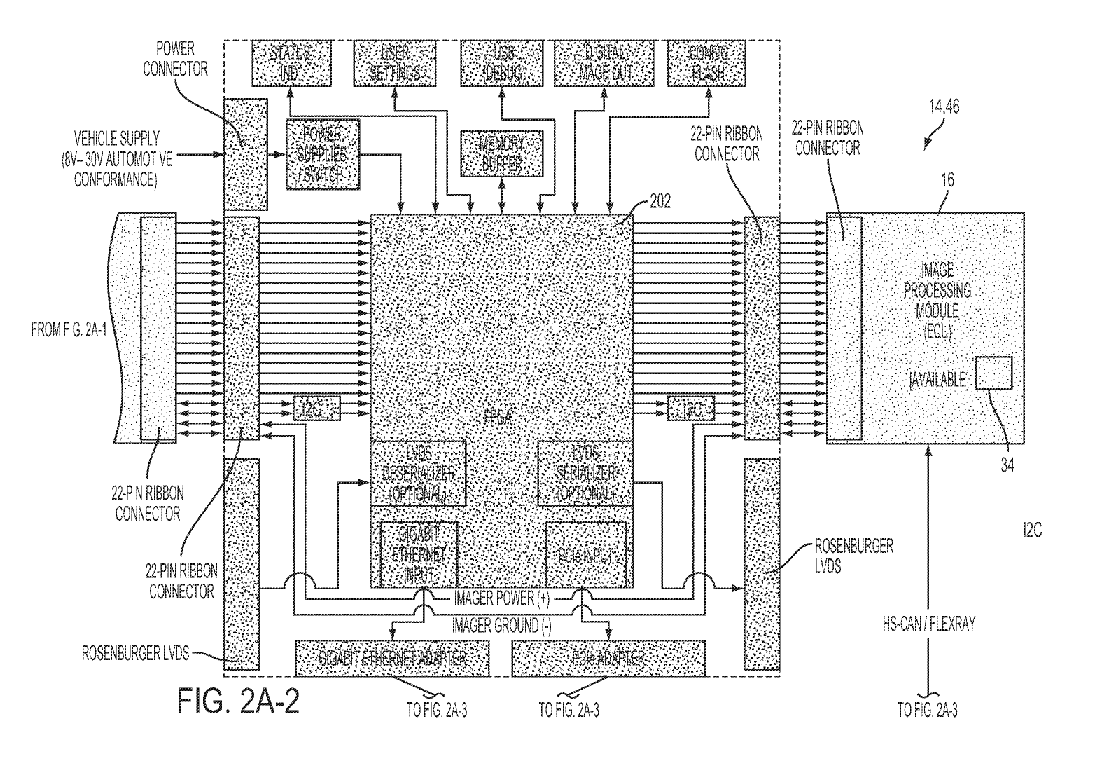

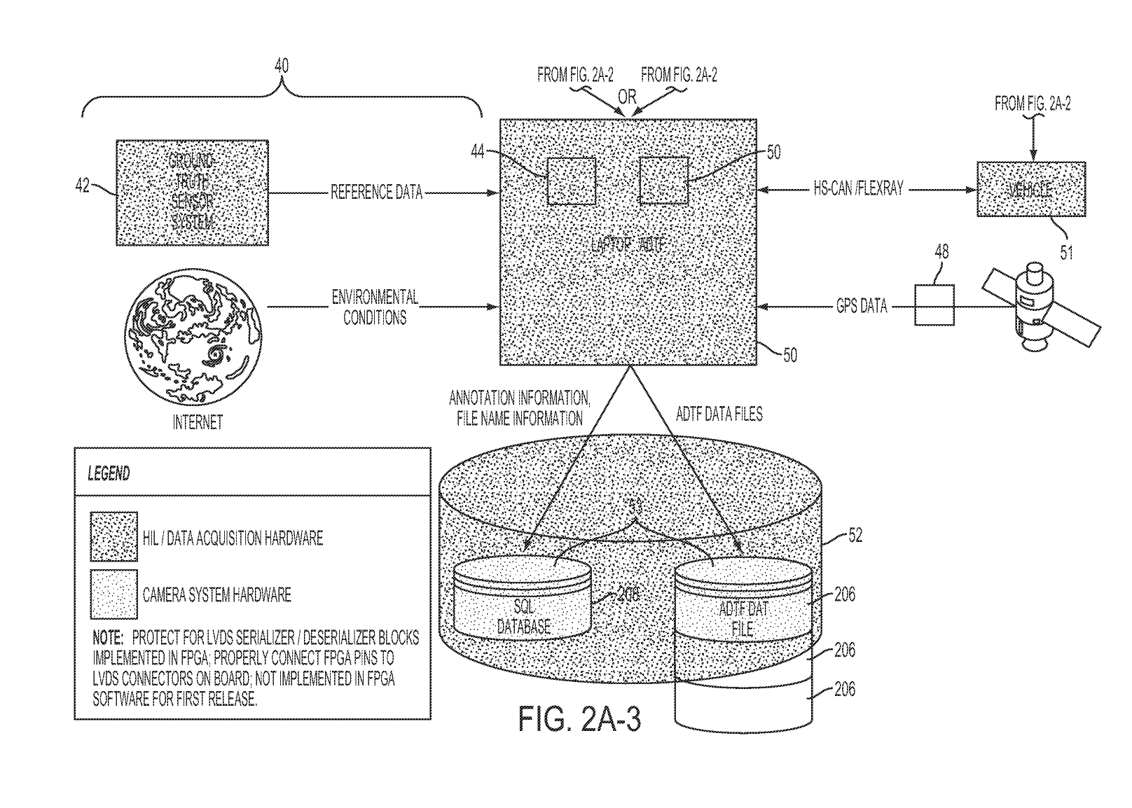

The software module 34 may use any suitable type of algorithm for determining the selected properties (e.g. for detecting pedestrians or other obstacles 36). It is desirable to determine the actual success rate achieved by the software module 34 at determining the selected properties. In order to do this, a test vehicle shown at 38 is provided as shown in FIGS. 2 and 2A. The test vehicle 38 includes a vehicle body 39, and the environmental sensing system (shown at 46) that is proposed for use in the production vehicle. The sensing system 46 may be referred to as the production sensing system 46 or the first environment sensing system 46. In this embodiment the sensing system 46 is the camera 14. Optionally, the test vehicle 38 may also include the production ECU 16 with the software module 34 contained in memory.

The test vehicle 38 optionally further includes a verification system 40, which is configured to determine the selected properties of the environment outside the test vehicle 38. The verification system 40 is selected to have a high (preferably perfect) success rate at determining the selected properties. Cost and practicality are less important when selecting the type of verification system to use since the verification system is not intended to be provided on the production vehicle 10.

The verification system 40 includes an environmental sensing system 42 and a verification system controller 44. The environmental sensing system 42 may be referred to as a verification sensing system 42, or a second sending system 42. In the embodiment shown in FIG. 2, the verification sensing system 42 may include a radar system or some other long range object sensing system. The verification system controller 44 has verification system software thereon that receives the radar data and uses it to detect the positions of obstacles 36 in the path of the test vehicle 38. The use of a radar system 42 may enable the verification system 40 to have a relatively high success rate at detecting obstacles 36 and determining their positions relative to the test vehicle 38.

The test vehicle 38 also includes a position sensing system 48 for detecting the particular position of the test vehicle 38 as it being driven. The position sensing system 48 may simply be a GPS system as is provided in many vehicles currently.

The test vehicle 38 may include a test data acquisition controller 50 and a memory 52. In the illustrated embodiment, the test data acquisition controller 50 is the same controller as the verification system controller 44; however, it could be a different controller as the verification system controller 44. The test vehicle 38 also includes a wireless internet connection, which will permit the test data acquisition controller 50 to draw selected information from the internet while the test vehicle 38 is in use. The selected information includes environmental data regarding the environment outside the vehicle. The environmental data includes at least one datum selected from the group of environmental data consisting of: the temperature, the dew point, the amount of cloud coverage, the humidity, the time for sunrise, the time for sunset, and the level and type of precipitation, if any. Other environmental data may also be drawn by the test data acquisition controller.

The test data acquisition controller 50 is further capable of receiving vehicle data from one or more vehicle controllers within the test vehicle 38. One of the vehicle controllers is shown at 51. The vehicle data may include one or more of vehicle speed, vehicle steering angle, operational state of windshield wipers, and operational state of vehicle headlights.

Thus equipped, the test vehicle 38 is driven along one or more routes so that it encounters a set of one or more selected environmental conditions. The selected environmental conditions may be selected to cover a broad range of conditions. For example, the environmental conditions may be selected to include conditions in which it is raining, in which it is snowing, in which it is nighttime, in which it is very bright, in which it is overcast, in which it is foggy. The test vehicle 38 may further be driven through conditions wherein two or more conditions occur simultaneous to further challenge the ability of the software module 34 and the production sensing system to detect obstacles 36. For example, the test vehicle 38 may be driven through conditions wherein it is raining and it is nighttime.

While the test vehicle 38 is being driven, the production sensing system 46 (i.e., the camera 14) is enabled and captures production system environment data (which, in this embodiment, is a stream of images, which may also be referred to as a video stream) relating to the environment outside the test vehicle 38. The production system data may be referred to as first environment data, and is recorded to the memory 52. Also, while the test vehicle 38 is being driven, the verification sensing system 42 (such as, for example, the radar system) captures verification system environment data, which may be referred to as second environment data, and which, in this embodiment, is radar signals relating to the environment outside the test vehicle 38. The verification system controller 44 determines the positions of obstacles 36 in the path of the test vehicle 38 (if any are present) based on the verification system data. The test data acquisition controller 50 records at least one of: the determinations of the verification system controller 44 and the verification system data, to the memory 52. When the production system data and either or both of the verification system data and the determinations made by the verification system controller 44 are recorded to the memory 52, the position sensing system 48 determines the position of the test vehicle 38, which may be recorded to the memory 52, and the test data acquisition controller 50 accesses the Internet to retrieve environmental condition data relating to the environmental conditions outside the test vehicle 38 at that particular instant in time, based on the vehicle's position that was determined by the position sensing system 48. The environmental condition data may include one or more of: the temperature, the dew point, the amount of cloud coverage, the humidity, the time for sunrise, the time for sunset, and the level and type of precipitation, if any. The environmental condition data may be retrieved from weather related websites or from any other suitable type of websites. The data recorded to the memory 52 will be time and date stamped and may be referred to as test data 53.

In situations where the test data acquisition controller 50 is unable to access the internet or to access the desired websites, an interface may be provided to permit a vehicle occupant to manually enter the desired environmental condition data so that it can still be recorded to the memory 52.

Once the test vehicle 38 has logged enough time driving in each of the selected environmental conditions the test data 53 in memory 52 can then be used to assess the success rate of the software module 34 at detecting obstacles 36 in different environmental conditions. In embodiments wherein the software module 34 and ECU 16 are provided in the test vehicle 38, the software module 34 can be used to determine the positions of any obstacles 36 during the driving of the test vehicle 38 through the different environmental conditions. In such an embodiment, a test vehicle occupant could determine right away if there are particular environmental conditions in which the software module 34 performs poorly relative to the verification system 40, which can be used to influence how much time the test vehicle 38 logs in those conditions. For example, if the software module 34 performs poorly during nighttime, one could optionally log more nighttime hours in the test vehicle 38 to ensure that there is ample test data for situations in which the software module performed poorly, to use when refining the performance of the software module 34.

The test data 53 stored in memory 52 may be stored in the form of one or more linked databases, which can be filtered based on, among other things, any of the environmental conditions. For example, the databases may be filtered to provide only the data taken when it was nighttime and it was raining.

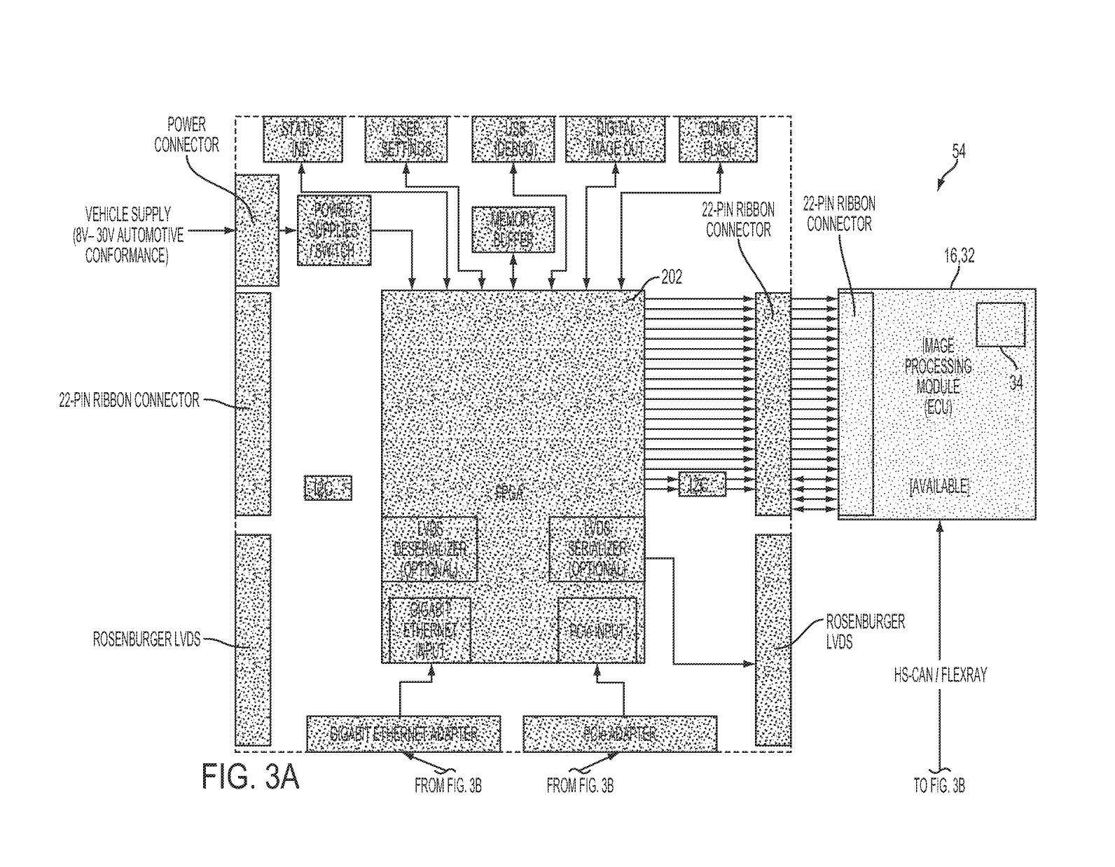

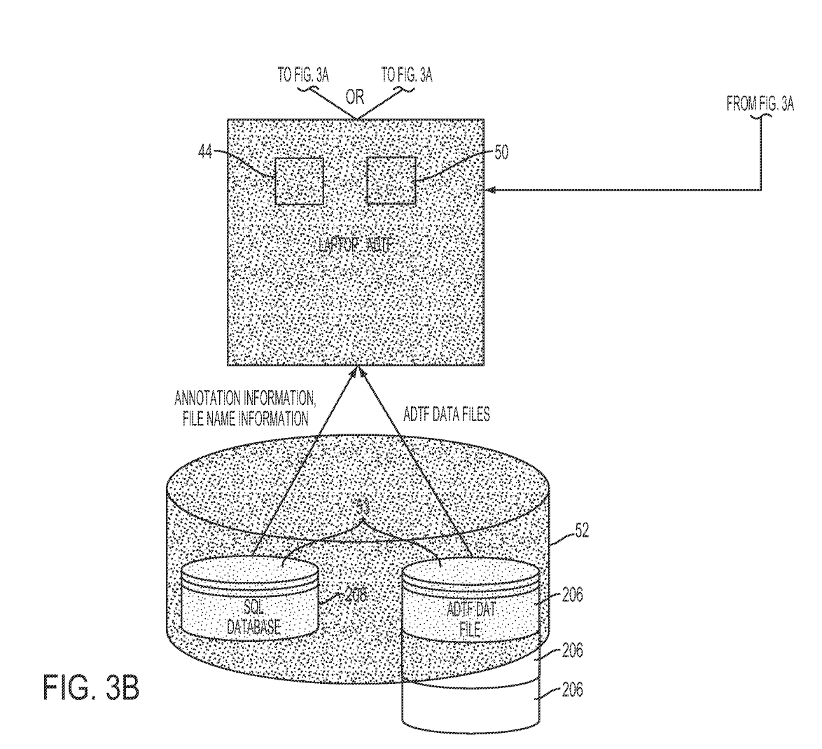

In any case, once the vehicle 38 has collected the test data 53 and stored it in memory 52 that data can be used to test and improve the performance of the software module 34 without further need to drive the vehicle 38. For example, a stationary test apparatus shown at 54 in FIG. 3 can be provided for use in testing the software module 34. The stationary test apparatus 54 includes the ECU 16, along with the software module 34. In this example, the stationary test apparatus 54 includes the ECU 16 on which the software module 34 is stored. An operator of the test apparatus 54 can then introduce the filtered production system data (or alternatively the unfiltered production system data) to the ECU 16 as if it came from the image sensor 24, along with whatever other data may be desired so that the ECU 16 receives all the data it would receive if it was in the test vehicle 38 driving. For example, this may include some vehicle data. The software module 34 can then process the filtered data to determine the positions of any obstacles 36 it detects. Its success rate can be measured because the data also includes the determinations made by the verification system 40. If the success rate of the software module 34 is less than a selected threshold, then the software module 34 can be revised or rewritten, and retested.

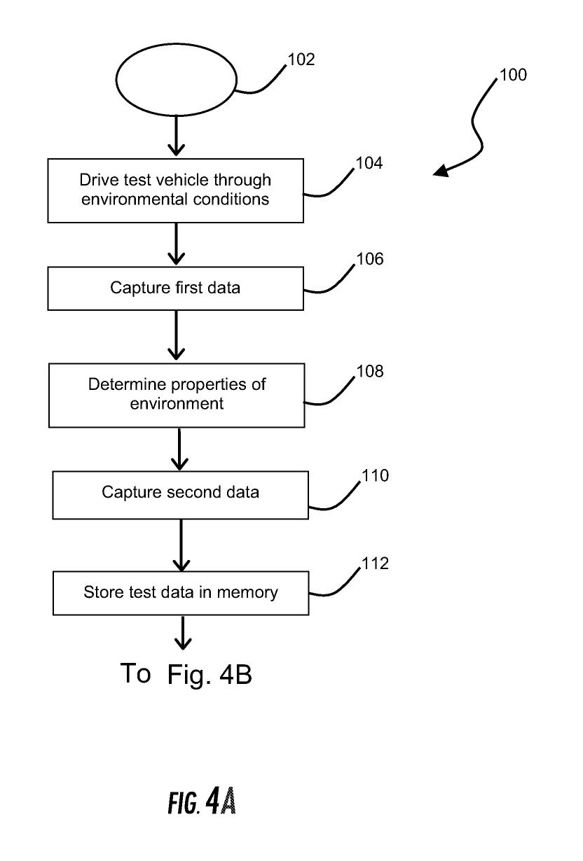

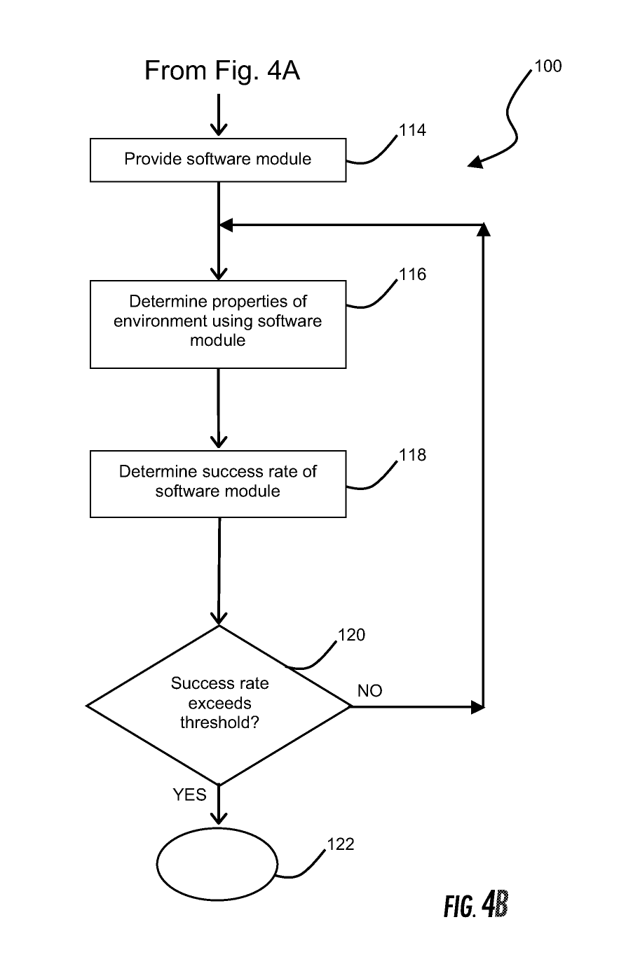

A method in accordance with the present invention is shown at 100 in FIGS. 4A and 4B. The start of the method is shown at 102. At step 104, the test vehicle 38 is driven through the selected set of environmental conditions. At step 106, the production system data, which in the embodiment shown are the camera images, are captured using the production sensing system 46 (which is the camera 14 in the embodiment shown in FIG. 1), as the test vehicle 38 is driven through the selected set of environmental conditions. At step 108, the verification system data is captured using the verification sensing system 42 as the test vehicle 38 is driving through the selected set of environmental conditions. At step 110, the verification system 40 is used to determine the selected properties of the environment (i.e. the positions of any obstacles 36 in the path of the test vehicle 38) based on the verification system data. Step 110 may be carried out while the test vehicle 38 is being driven through the selected set of environmental conditions, however, it is alternatively possible for these determinations to be made afterwards. At step 112, the determined positions of any obstacles 36 are stored in memory 52 in embodiments wherein the determined positions are determined while the test vehicle 38 is being driven. Additionally or alternatively, the first test data is stored in memory 52. In embodiments wherein the determinations of the selected properties are not made while the vehicle 38 is driving, then it will be understood that only the verification system data are data are recorded to the memory 52. In addition to recording one or both of the verification system data and the determinations made by the verification system, the following data are also recorded to the memory 52: the production system data, the vehicle data relating to at least one property of the vehicle, the positional information for the vehicle, the time of day, and the environmental condition data relating to the environmental conditions outside the vehicle, all of which are described above.

The software module 34 is provided at step 114. At step 116, it is used to determine the selected properties of the environment based on the production system data. At step 118, the success rate of the software module 34 at determining the selected properties of the environment is determined, based at least in part on the determinations of the selected properties of the environment made by the verification system 40. At step 120, it is determined whether the success rate determined at step 118 is sufficiently high to achieve the desired performance parameters set for the software module 34. In other words, it is determined whether the success rate determined in step 118 exceeds a selected success rate. If it does, then the method may be stopped. If the success rate of the software module 34 is considered too low for use in the production vehicle 10, then the software module 34 may be revised or completely rewritten and steps 116, 118 and 120 may be repeated using the new software module (i.e. the revised or rewritten software module). Steps 116, 118 and 120 may be repeated iteratively using new (i.e. revised or rewritten) software modules until the success rate determined at step 118 exceeds the selected success rate, at which point the method 100 ends, as shown at end 122.

While the test vehicle 38 has been shown to include the verification system 40, it may be possible for the verification system 40 to be omitted. For example, the production system data may be reviewed by a person in order to determine when obstacles appear in the video stream and the positions of the obstacles. Alternatively, it is possible that a person could ride in the test vehicle along with the driver and could note the appearance and position of obstacles while the production system data is being collected.

In such an embodiment, step 108 may therefore be omitted from the method shown in FIGS. 4A and 4B, and step 110 may take place using the production system data 106.

It will be noted that the collection of environmental condition data and the storing of the environmental condition data in memory in association with the production system data collected during the driving of the test vehicle 38 is valuable in that it permits the easy evaluation or verification of the performance of the software module 34 specifically under different environmental conditions. For example, if the software module 34 is updated after the production system data has been collected, the performance of the software module 34 can be verified under specific environmental conditions.

It will also be noted that storing vehicle data, such as the operational state of the headlights and other data can be used to augment the accuracy of the environmental data. For example, if the environmental condition data suggests that it is rainy weather in the vicinity of the test vehicle 38, then it is possible but not definite that it is actually raining in the vicinity of the test vehicle 38. If the test data is filtered for images taken when the environmental condition data suggests that it is rainy and when the vehicle's windshield wipers are on, then there is a greater likelihood that it is actually raining in the vicinity of the vehicle.

On a more detailed level, and with reference to FIG. 2A, the image sensor 24 of the camera 14 may communicate with an optional serializer/deserializer (which may be referred to as a SerDes) shown at 200 via a 22 pin connector. After the SerDes 200 deserializes the image data, it may be communicated with an FPGA shown at 202 via a 22 pin connector. The FPGA 202 communicates the image data both to the ECU 16 as would have been done directly from the image sensor 24. The SerDes 200 permits the use of a cable having a selected length between the image sensor 24 and the FPGA 202 so that the FPGA 202 need not be positioned immediately adjacent the image sensor 24. This permits the FPGA 202 and the ECU 16 to be positioned proximate, for example, the glove compartment of the vehicle, while the image sensor 24 and the lens assembly 22 may be positioned, for example, proximate the top of the windshield.

The FPGA 202 communicates time synchronized images, frame counter information, and I²C commands to the test data acquisition controller 50 for recording to the memory 52 as the production system data. The test data acquisition controller 50 may be provided in the form of a laptop computer. The memory 52 may be provided by an external memory storage unit for storage of the relatively large amounts of data received by the test data acquisition controller 50 during driving of the test vehicle 38,

To facilitate timing requirements between the FPGA 202 and the test data acquisition controller 50, the FPGA 202 may buffer one or more sets of four exposures in a local high-speed memory. In the embodiment described herein, each image may be made up from a set of four exposures, each taken using different camera settings (e.g. exposure settings) so as to provide a high dynamic range image. It will be understood, however, that, for the purposes of the invention each image may be made up one or more exposures.

To facilitate the handling of the data, the test data acquisition controller 50 include an ADTF (Automotive Data and Time-triggered Framework). In particular, the verification system data, the production system data, the positional information (i.e. GPS data) and at least some of the vehicle data may be received by the ADTF and stored (along with date and time stamping) in the form of an ADTF data file shown at 206. Each ADTF file 206 may correspond to some selected period of driving time, such as, for example, about one minute of driving time.

When an ADTF file 206 is saved in the ADTF environment, other data, such as the environmental condition data, the determinations of the obstacles 36 made by the verification system 40 (if provided) and some vehicle data (e.g. the operational state of the windshield wipers), may be stored in an SQL database shown at 208, together with a link to the associated ADTF data file. The link may be, for example, the name of the associated ADTF data file 206. The SQL database may be queried (filtered) as desired to create a playlist of selected ADTF data files, which are played back to the ECU 16 in order to test the software module 34.

The vehicle data may, as noted above, be used to confirm the accuracy of some of the environmental condition data. For example, as noted above, one can query the SQL database 208 to find all the ADTF files in which the weather information indicates it is raining and in which the operational state of the windshield wipers indicates that they are on. As another example, one may look for ADTF files in which the vehicle was driving in the dark, and may thus query the database for files in which the time stamp on the file is after the local sunset time and in which the operational state of the vehicle headlight system is on.

It may be desirable to verify the performance of the software module 34 under high glare conditions. For this purpose, the position of the sun in the sky may be downloaded from the Internet based on the position of the vehicle 38 and may be stored in memory 52. Additionally the bearing of the vehicle 38, which may be obtained from an on-board compass may be stored in memory 52. To find potentially high glare situations, the data may be filtered for situations in which it is sunny out, and where the sun is in such a position in the sky that it would likely appear in the field of view of the camera 14. Thus, to filter the test data for high glare conditions, both environmental condition data and vehicle data are involved.

Referring to FIG. 3, the test apparatus 54 may further include the FPGA 202, the memory 52 containing the test data 53, and a means for filtering the test data 53, a means for transmitting the production system data (i.e. the video stream) to the FPGA 202 for transmittal to the ECU 16, and a means for transmitting pertinent vehicle data to the ECU 16. The aforementioned means may be incorporated into the test data acquisition controller 50.

Upon startup of the test apparatus 54, the FPGA 202 may store some images in the form of individual frames for transmittal to the ECU 16 in a buffer. The FPGA 202 may then select the appropriate first frame requested by the ECU 16 (via messages over the I²C bus), and may then transmit it to the ECU 16. The FPGA 202 can then continue to transmit frames/images to the ECU 16 to meet the timing requirements of the ECU 16 while backfilling the buffer from the ADTF.

In some cases in this description certain elements are described as being included in both the production vehicle 10 and in the test vehicle 38, and some elements are described as being in both test vehicle 38 and in the test apparatus 54. For example, the FPGA 202 is described as being in the test vehicle 38 and in the test apparatus 54. As another example, the camera 14 is described as being in the production vehicle 10 and in the test vehicle 38. It will be understood however, that the components shown and described as being in two systems need not be physically the same components, and need not be identical components. It is enough for them to be functional equivalents to each other. For example, the FPGA 202 shown in the test apparatus 54 need not physically be the actual FPGA in the test vehicle 38 and need not be absolutely identical to the FPGA in the test vehicle 38, but instead could be a functional equivalent to the FPGA 202 in the test vehicle 38 in the ways and for the purposes described.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, an array of a plurality of photosensor elements arranged in 640 columns and 480 rows (a 640×480 imaging array), with a respective lens focusing images onto respective portions of the array. The photosensor array may comprise a plurality of photosensor elements arranged in a photosensor array having rows and columns. The logic and control circuit of the imaging sensor may function in any known manner, such as in the manner described in U.S. Pat. Nos. 5,550,677; 5,877,897; 6,498,620; 5,670,935; 5,796,094; and/or 6,396,397, and/or U.S. provisional application Ser. No. 61/613,651, filed 2012; Ser. No. 61/607,229, filed Mar. 6, 2012; Ser. No. 61/605,409, filed Mar. 1, 2012; Ser. No. 61/602,878, filed Feb. 24, 2012; Ser. No. 61/602,876, filed Feb. 24, 2012; Ser. No. 61/600,205, filed Feb. 17, 2012; Ser. No. 61/588,833, filed Jan. 20, 2012; Ser. No. 61/583,381, filed Jan. 5, 2012; Ser. No. 61/579,682, filed Dec. 23, 2011; Ser. No. 61/570,017, filed Dec. 13, 2011; Ser. No. 61/568,791, filed Dec. 9, 2011; Ser. No. 61/567,446, filed Dec. 6, 2011; Ser. No. 61/567,150, filed Dec. 6, 2011; Ser. No. 61/565,713, filed Dec. 1, 2011; Ser. No. 61/559,970, filed Nov. 15, 2011; Ser. No. 61/552,167, filed Oct. 27, 2011; Ser. No. 61/540,256, filed Sep. 28, 2011; Ser. No. 61/513,745, filed Aug. 1, 2011; Ser. No. 61/511,738, filed Jul. 26, 2011; and/or Ser. No. 61/503,098, filed Jun. 30, 2011, which are all hereby incorporated herein by reference in their entireties. The system may communicate with other communication systems via any suitable means, such as by utilizing aspects of the systems described in PCT Application No. PCT/US10/038477, filed Jun. 14, 2010 and published Dec. 16, 2010 as International Publication No. WO 2010/144900, and/or U.S. patent application Ser. No. 13/202,005, filed Aug. 17, 2011 (Attorney Docket MAG04 P-1595), which are hereby incorporated herein by reference in their entireties.

The camera or cameras may comprise any suitable cameras or imaging sensors or camera modules, and may utilize aspects of the cameras or sensors described in U.S. patent application Ser. No. 12/091,359, filed Apr. 24, 2008 (Attorney Docket MAG04 P-1299); and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,965,336; 7,004,606; and/or 7,720,580, and/or PCT Application No. PCT/US2008/076022, filed Sep. 11, 2008 and published Mar. 19, 2009 as International Publication No. WO/2009/036176, and/or PCT Application No. PCT/US2008/078700, filed Oct. 3, 2008 and published Apr. 9, 2009 as International Publication No. WO/2009/046268, which are all hereby incorporated herein by reference in their entireties. The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,123,168; 7,004,606; 6,946,978; 7,038,577; 6,353,392; 6,320,176; 6,313,454; and 6,824,281, and/or International Publication No. WO 2010/099416, published Sep. 2, 2010, and/or PCT Application No. PCT/US10/47256, filed Aug. 31, 2010 and published Mar. 10, 2011 as International Publication No. WO 2011/028686, and/or U.S. patent application Ser. No. 12/508,840, filed Jul. 24, 2009, and published Jan. 28, 2010 as U.S. Pat. Publication No. US 2010-0020170; and/or U.S. provisional application Ser. No. 61/511,738, filed Jul. 26, 2011; and/or Ser. No. 61/503,098, filed Jun. 30, 2011, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional application Ser. No. 60/618,686, filed Oct. 14, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018-A1, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. Nos. 7,255,451 and/or 7,480,149; and/or U.S. patent application Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in PCT Application No. PCT/US2011/056295, filed Oct. 14, 2011 (Attorney Docket DON01 FP-1725(PCT)), which is hereby incorporated herein by reference in its entirety). Optionally, the vision system (utilizing the rearward facing camera and other cameras disposed at the vehicle with exterior fields of view) and/or the camera or cameras as part of a vehicle vision system that comprises or utilizes a plurality of cameras (such as utilizing a rearward facing camera and sidewardly facing cameras and a forwardly facing camera disposed at the vehicle), may provide a display of a top-down view or birds-eye view of the vehicle or a surround view at the vehicle, such as by utilizing aspects of the vision systems described in PCT Application No. PCT/US10/25545, filed Feb. 26, 2010 and published on Sep. 2, 2010 as International Publication No. WO 2010/099416, and/or PCT Application No. PCT/US10/47256, filed Aug. 31, 2010 and published Mar. 10, 2011 as International Publication No. WO 2011/028686, and/or PCT Application No. PCT/US11/62755, filed Dec. 1, 2011 (Attorney Docket MAG04 FP-1790(PCT)), and/or U.S. patent application Ser. No. 13/333,337, filed Dec. 21, 2011 (Attorney Docket DON01 P-1797), and/or U.S. provisional application Ser. No. 61/588,833, filed Jan. 20, 2012; Ser. No. 61/570,017, filed Dec. 13, 2011; Ser. No. 61/559,970, filed Nov. 15, 2011; and/or Ser. No. 61/540,256, filed Sep. 28, 2011, which are hereby incorporated herein by reference in their entireties.

Optionally, the video mirror display may be disposed rearward of and behind the reflective element assembly and may comprise a display such as the types disclosed in U.S. Pat. Nos. 7,855,755; 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent application Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

While the above description constitutes a plurality of embodiments of the present invention, it will be appreciated that the present invention is susceptible to further modification and change without departing from the fair meaning of the accompanying claims.

1. A method of determining a success rate of a sensing system when determining properties of the environment outside a vehicle, said method comprising:
(a) driving a test vehicle through a set of environmental conditions;
(b) capturing first environment data relating to the environment outside the test vehicle using a first environment sensing system, during step (a);
(c) determining properties of the environment;
(d) recording to a memory (i) the first environment data, (ii) the determined properties of the environment, (iii) vehicle data relating to at least one property of the vehicle while the vehicle is driven during step (a), and (iv) environmental condition data relating to the environmental conditions outside the vehicle while the vehicle is driven during step (a);
(e) providing a processor and software executable by the processor;
(f) using the software to determine properties of the environment based on the first environment data;
(g) determining a success rate of the software at determining the properties of the environment based on the determination of properties of the environment made in step (c);
(h) determining whether the success rate determined in step (g) exceeds a selected success rate; and
(i) iteratively repeating steps (f), (g) and (h) using modified software until the success rate determined at step (g) exceeds the selected success rate.

2. A method as claimed in claim 1, wherein a first iteration of step (g) takes place during step (a).

3. A method as claimed in claim 1, wherein the first environment data comprises images captured from a camera on board the vehicle.

4. A method as claimed in claim 1, wherein the properties of the environment include the presence of obstacles in the path of the vehicle.

5. A method as claimed in claim 1, wherein the properties of the environment include the presence of pedestrians in the path of the vehicle.

6. A method as claimed in claim 1, wherein the environmental condition data includes at least one datum selected from the group of environmental condition data consisting of temperature, dew point, amount of cloud coverage, humidity, time for sunrise, time for sunset, a level of precipitation and a type of precipitation.

7. A method as claimed in claim 1, wherein the vehicle data includes at least one datum selected from the group of vehicle data consisting of vehicle speed, vehicle steering angle, operational state of windshield wipers, and operational state of vehicle headlights.

8. A method as claimed in claim 1, wherein at least some of the environmental condition data is obtained from the internet via a wireless connection thereto on board the vehicle, and is based at least in part on positional information relating to the vehicle.

9. A method as claimed in claim 8, wherein the positional information is taken from a GPS sensor on board the vehicle.

10. A method as claimed in claim 8, wherein the positional information for the vehicle is recorded to the memory in step (e).

11. A method as claimed in claim 1, wherein the environmental condition data covers a plurality of different environmental conditions, and wherein step (f) includes:
(j) selecting a subset of environmental conditions covered by the environmental condition data; and
(k) using software to determine properties of the environment based on a subset of the first environment data taken under environmental conditions corresponding to the environmental conditions selected in step (j).

12. A method as claimed in claim 1, wherein step (c) takes place during step (a).

13. A method as claimed in claim 1, wherein the vehicle data includes bearing information for the vehicle and wherein the environmental condition data includes the position of the sun in the sky during step (a).

14. A method as claimed in claim 1, further comprising recording to the memory in step (e) the time of day during step (a).

15. A method as claimed in claim 1, further comprising capturing second environment data relating to the environment outside the test vehicle using a second environment sensing system, during step (a), and wherein step (d) further includes recording the second environment data to the memory, and wherein the determination of properties of the environment in step (c) are made at least in part on the second environment data.

16-21. (canceled)

22. A method of determining a success rate of a sensing system when determining properties of the environment outside a vehicle, said method comprising:
(a) driving a test vehicle through a set of environmental conditions;
(b) during step (a), capturing first environment data relating to the environment outside the test vehicle using a first environment sensing system, wherein said first environment sensing system comprises at least one camera;
(c) during step (a), capturing second environment data using a second environment sensing system;
(d) recording to a memory (i) the first environment data, (ii) the second environment data, (iii) vehicle data relating to at least one property of the vehicle while the vehicle is driven during step (a), and (iv) environmental condition data relating to the environmental conditions outside the vehicle while the vehicle is driven during step (a);
(e) determining properties of the environment based at least in part on the second environment data;
(f) providing a processor and software executable by the processor;
(g) using the software to determine properties of the environment based on the first environment data;
(h) determining a success rate of the software at determining the properties of the environment based on a comparison of the determination of properties of the environment in step (g) and the determination of properties of the environment made in step (e);
(i) determining whether the success rate determined in step (h) exceeds a selected success rate; and
(j) iteratively repeating steps (g), (h) and (i) using modified software until the success rate determined at step (h) exceeds the selected success rate.

23. A method as claimed in claim 22, wherein the properties of the environment include at least one of the presence of obstacles in the path of the vehicle and the presence of pedestrians in the path of the vehicle.

24. A method as claimed in claim 22, wherein at least one of (i) the environmental condition data includes at least one datum selected from the group of environmental condition data consisting of temperature, dew point, amount of cloud coverage, humidity, time for sunrise, time for sunset, a level of precipitation and a type of precipitation, (ii) the vehicle data includes at least one datum selected from the group of vehicle data consisting of vehicle speed, vehicle steering angle, operational state of windshield wipers, and operational state of vehicle headlights, and (iii) at least some of the environmental condition data is obtained from the internet via a wireless connection thereto on board the vehicle, and is based at least in part on positional information relating to the vehicle.

25. A method of determining a success rate of a sensing system when determining properties of the environment outside a vehicle, said method comprising:
(a) driving a test vehicle through a set of environmental conditions;
(b) during step (a), capturing first environment data relating to the environment outside the test vehicle using a first environment sensing system, wherein said first environment sensing system comprises at least one camera;
(c) during step (a), capturing second environment data using a second environment sensing system, wherein said second environment sensing system comprises at least one radar sensor;
(d) determining properties of the environment based at least in part on the second environment data, wherein the determined properties of the environment include the presence of an object in the path of the vehicle;
(e) providing a processor and software executable by the processor;
(f) using the software to determine properties of the environment based on the first environment data;
(g) determining a success rate of the software at determining the properties of the environment based on a comparison of the determination of properties of the environment in step (f) and the determination of properties of the environment made in step (d);
(h) determining whether the success rate determined in step (g) exceeds a selected success rate; and
(i) iteratively repeating steps (f), (g) and (h) using modified software until the success rate determined at step (g) exceeds the selected success rate.

26. A method as claimed in claim 25, comprising capturing environmental condition data relating to the environmental conditions outside the vehicle while the vehicle is driven during step (a), wherein determining a success rate of the software in step (g) comprises determining a success rate of the software during exposure of the vehicle to different environmental conditions while the vehicle is driven during step (a).
